(19) United States
(12) Patent Application Publication
(10) Pub. No.: US 2018/0211296 A1
(43) Pub. Date: Jul. 26, 2018

(54) System for Isolating and Associating Screen Content

(71) Applicant: Markable Inc, Madison, WI (US)

(72) Inventors: Jonas Grimfelt, Brooklyn, NY (US); Joy Tang, Madison, WI (US)

(73) Assignee: Markable Inc, Madison, WI (US)

(21) Appl. No.: 15/876,622

(22) Filed: Jan. 22, 2018

Related U.S. Application Data
(60) Provisional application No. 62/449,302, filed on Jan. 23, 2017.

(51) Int. Cl. G06Q 30/06; G06F 17/30

(52) U.S. Cl. CPC G06Q 30/0601; G06F 17/30554; G06F 17/30864

(57) ABSTRACT

A system and a method for associating network connected device displayed screen content are disclosed. The method includes providing the network connected device having a display screen. A search query is prepared based on a selection of information from a portion of the display screen using an artificial perimeter. The selection of information corresponds to at least one of underlying pixels, meta-data, and media components of the content within the artificial perimeter. The search query is sent over a network to a visual search processor for retrieving a search result. The search result is retrieved upon matching of the information present in the search query with data accessible to the visual search processor. The search result is forwarded by the visual search processor to the network connected device. Further, the search result is received by the network connected device and thereafter is displayed on the display screen.

### CROSS-REFERENCE TO RELATED PATENT APPLICATION

The present application is related to and claims priority of U.S. provisional patent application titled “System for isolating and associating screen content”, Ser. No. 62/449,302, filed on Jan. 23, 2017, the description of the same is incorporated herein in its entirety.

### FIELD OF THE INVENTION

The present disclosure is generally related to information retrieval over a communication network, and more particularly related to a method for associating content displayed on a network-connected device with other data accessible over the communication network.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Current broadband network capabilities enable Internet users to obtain vast amount of data. Further, a typical network-connected or networked computing device (“NCD”) either has access to, or is integrated with in the case of typical mobile devices, camera technologies with which an NCD user can obtain photographic information from the user's environment for processing or communication with other NCD users.

While an NCD user has access to a vast amount of data through its network and its physical environment, acquiring information in an organized manner typically involves issuing queries to network-connected databases, servers, and request processors which maintain vast indices of information (e.g., Internet web pages) against which the queries can be compared and, if matched, returned to the NCD user as a potential source of additional information on the queried topic. A very basic example of an NCD user acquiring additional information on a topic would involve the user navigating his NCD's Internet web browser to a search engine (e.g., Google.com), textually describing the subject of the user's inquiry into a predefined field, sending the request to the search engine's servers for processing, and waiting for a short time to view tabulated or otherwise organized results of the inquiry. Using the tabulated results—which may appear textually, or in a multimedia form—the user may qualify whether and to what extent the results are valid to the inquiry and access one or more of the results to obtain the requested additional information.

However, textual and semantic search processes face limitations, those limitations largely being based on the user's ability (or inability) to textually or semantically describe that for which the user is searching. Where an NCD user is requesting additional information concerning a known subject (e.g., Herman Melville's novel Moby Dick), that knowledge will literally translate into textual and/or semantic queries that will more likely lead to valid search results: e.g., such a user could simply type “herman melville,” “moby dick,” or variations thereof to produce millions of results related to the novel. Further, semantic search capabilities utilized by most major Internet search engines correct for spelling and/or grammatical errors.

More problematic, however, is obtaining valid search engine results when the NCD user: (i) does not know about exactly for what he or she is querying; or (ii) knows about what he or she is searching, but cannot sufficiently articulate that subject's description using text. Moreover, an NCD's user ability to search for and acquire any information is limited to his or her native ability to input a query into the NCD. This generally will be limited to alphanumeric characters and symbols (e.g., via a QWERTY key system). To the extent a potential search subject may appear within an Internet browser window, the subject may have visible text or underlying meta data which the user can select within the browser and turn that data into a query (e.g., the “Search Google For” shell extension in Google's Chrome® browser).

Beyond textual search and semantic search, visual search—the query and return of image—allows NCD users in several contexts a very accurate and precise means of obtaining information about an image and subjects thereof. Visual search techniques—which can be applicable to images, video, and 3D models, among other media—generally fall in two categories. The first category is concept-based retrieval, wherein the subject reference includes metadata tags which themselves are the data which the visual search engine associates to a query. The second category is content-based retrieval, where the visual search engine processes color, texture, shape, and other features to associate references to a query. While processing visual search queries for lone images may result in contextless search results—i.e., mere identification of the search subject, if possible—collections of images may be simultaneously queried to provide context and lead to more-valid search results.

A basic example of the utility of visual search involves an NCD user taking a photograph of a subject, turning the image into a search query, sending the search query to a visual search engine, and awaiting information related to the identity and other results (e.g., where the subject may be purchased). Alternatively, an NCD user may simply isolate one or more portions of the NCD's display, where applicable, and perform the same process on image content displayed thereon. Whether an NCD has both a screen and camera technology (e.g., most current smartphones) or whether the NCD has just a screen (e.g., a desktop computer), a need exists to enable the NCD user to most-easily perform visual search functions by interacting with the medium in which the NCD is representing the visualizations, i.e., its screen.

Generally, the present invention's innovations, as the Detailed Description will elaborate, address the shortcomings of the prior art with regard to isolating and associating NCD screen content.

### SUMMARY OF THE INVENTION

It will be understood that this disclosure in not limited to the particular systems, apparatus, and methodologies described, as there can be multiple possible embodiments of the present disclosure which are not expressly illustrated in the present disclosure. It is also to be understood that the terminology used in the description is for the purpose of describing the particular versions or embodiments only, and is not intended to limit the scope of the present disclosure.

The present invention is a system for isolating and associating content displayed on a display screen of a network connected device. The system incorporates an omnipresent “lens” layer virtually operating over and above the display screen of the network connected device. The network connected device displays cached screen content on the display screen. Further, the cached screen content is isolated and transformed into a visual search query. The system employs a series of networked hardware and software modules to perform visual search tasks and return results to the network connected device of the user for providing further information (e.g., identity, purchase opportunities, etc.) regarding the visual search query.

### BRIEF DESCRIPTION OF THE DRAWINGS

The accompanying figures and drawings, incorporated into and forming part of the specification, service to further illustrate the present invention, its various principles and advantages, and varying embodiments. It is to be noted, however, that the accompanying figures illustrate only typical embodiments of the present invention and are not to be considered limiting of its scope as the present invention may admit other equally effective embodiments.

FIG. 1A illustrates a network connection diagram 10 of a system 13 for associating a network connected device 12 displayed content, according to an embodiment.

FIG. 1B illustrates an exemplary platform architecture 100 for associating the network connected device 12 displayed content, according to an embodiment.

FIG. 2 illustrates an exemplary implementation of the platform architecture 100, according to an embodiment.

FIG. 3 illustrates an exemplary mobile device 300 receiving a search result via a push notification, according to an embodiment.

FIG. 4 illustrates an exemplary scenario of a method for performing a visual search of a screen content using a mobile device 400, according to an embodiment.

FIG. 5 illustrates another exemplary scenario of a method for performing a visual search of a partial screen content using a mobile device 500, according to an embodiment.

FIG. 6 illustrates another exemplary scenario of a method for performing a visual search of native screen content using a mobile device 600, according to an embodiment.

FIG. 7 illustrates an exemplary user interface after a visual search is performed using a mobile device 700, according to an embodiment.

FIG. 8 illustrates another exemplary user interface after a visual search is performed using a mobile device 800, according to an embodiment.

FIG. 9 illustrates another exemplary user interface after a visual search is performed using a mobile device 900, according to an embodiment.

FIG. 10 illustrates another exemplary user interface after a visual search is performed using a mobile device 1000, according to an embodiment.

FIG. 11 illustrates an alternate embodiment of the system 13 for associating the network connected device 12 displayed video content, according to an embodiment.

FIG. 12 illustrates a flowchart 1200 showing a method for associating the network connected device 12 displayed content, according to an embodiment.

### DETAILED DESCRIPTION OF THE INVENTION

The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the preferred, systems and methods are now described.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

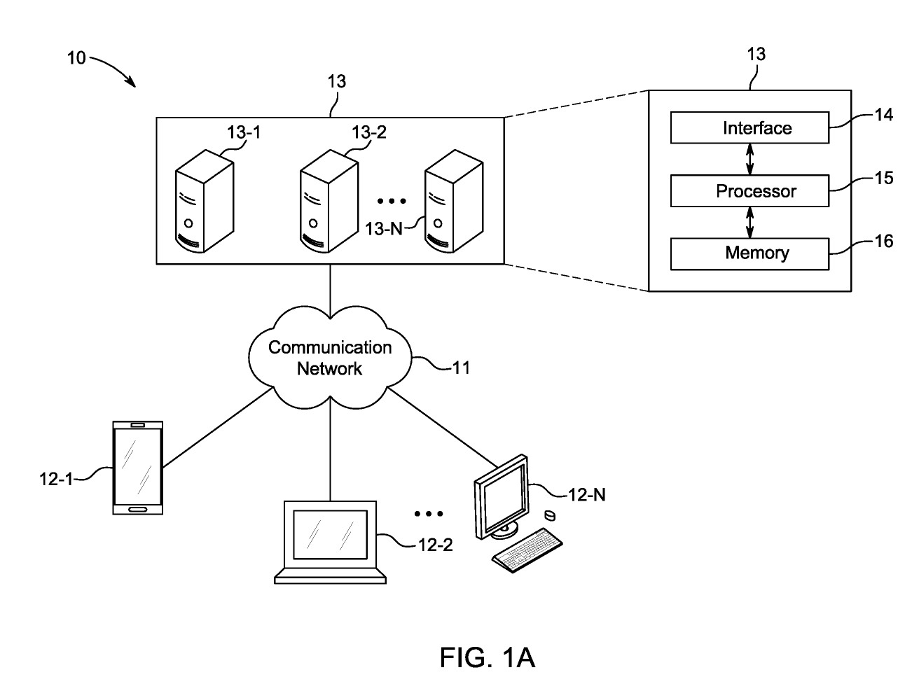

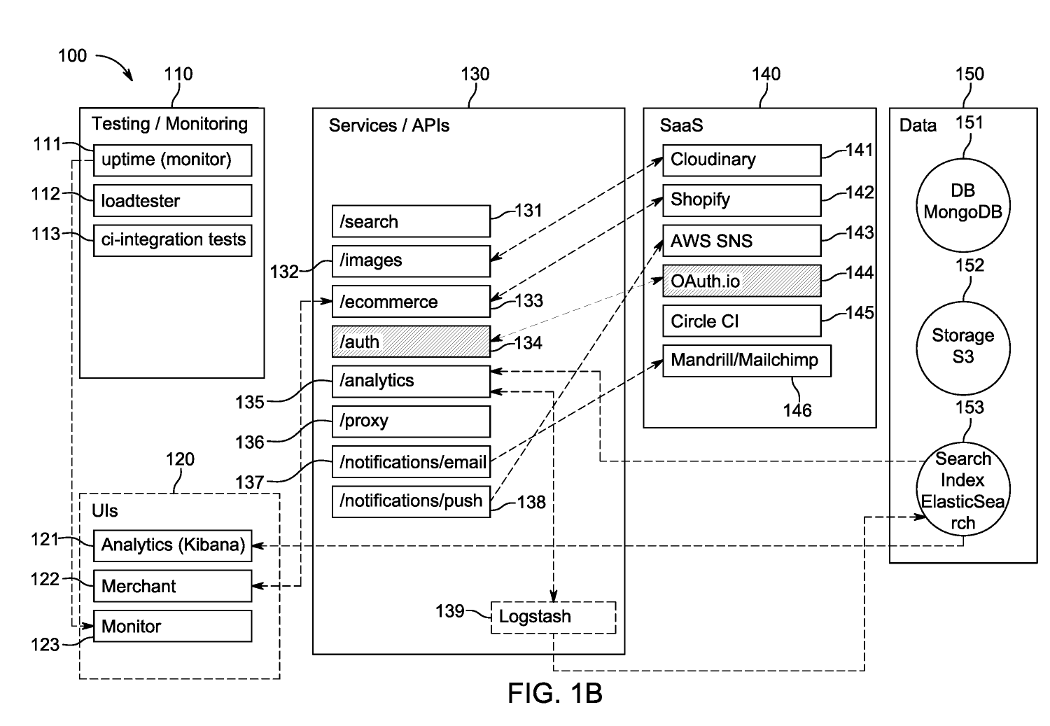

FIG. 1A illustrates a network connection diagram 10 of a system 13 i.e. a visual search server for associating a network connected device 12 displayed content, according to an embodiment. The network connection diagram 10 illustrates a communication network 11 connected to a plurality of systems 13-1 to 13-N (henceforth referred as the system 13 for ease of explanation). Further, a plurality of network connected devices 12-1 to 12-N (henceforth referred as the network connected device 12) are illustrated to be connected with the communication network 11.

The communication network 11 may be implemented using at least one communication technique selected from Visible Light Communication (VLC), Worldwide Interoperability for Microwave Access (WiMAX), Long term evolution (LTE), Wireless local area network (WLAN), Infrared (IR) communication, Public Switched Telephone Network (PSTN), Radio waves, and any other wired and/or wireless communication technique known in the art. In one case, the communication network 11 may be a cloud computing network.

The network connected device 12 may refer to a computing device used by a user, to prepare a search query. The network connected device 12 may be realized through a variety of computing devices, such as a desktop 12-N, a computer server, a laptop 12-2, a personal digital assistant (PDA), a mobile device 12-1, a tablet computer, and the like. The network connected device 12 may comprise a display screen. The search query may be prepared based on a selection of information from at least one portion of the display screen of the network connected device 12. The selection of information may be done manually by the user or using a programmed script. The selection of information may be made using an artificial perimeter present on the display screen of the network connected device 12. In one case, the selection of information may correspond to at least one of underlying pixels, meta-data, and media components of content within the artificial perimeter. The artificial perimeter may henceforth be referred as a lens-type bounding box. Successively, the user may send the search query to the system 13 over the communication network 11.

The system 13 may comprise a plurality of interfaces, a plurality of processors, and a plurality of memories. The plurality of interfaces, the plurality of processors, and the plurality of memories are henceforth referred as an interface 14, a processor 15, and a memory 16 respectively, for the ease of explanation.

The interface 14 may be used to interact with or program the system 13. The interface 14 may either be a Command Line Interface (CLI) or a Graphical User Interface (GUI).

The processor 15 may execute computer program instructions stored in the memory 16. The processor 15 may also be configured to decode and execute any instructions received from one or more other electronic devices or one or more remote servers. In an embodiment, the processor 15 may also be configured to process the search query received from the network connected devices 12-1 to 12-N. The processor 15 may include one or more general purpose processors (e.g., INTEL microprocessors) and/or one or more special purpose processors (e.g., digital signal processors or Xilinx System On Chip (SOC) Field Programmable Gate Array (FPGA) processor). The processor 15 may be configured to execute one or more computer-readable program instructions, such as program instructions to carry out any of the functions described in this description.

The memory 16 may include a computer readable medium. A computer readable medium may include volatile and/or non-volatile storage components, such as optical, magnetic, organic or other memory or disc storage, which may be integrated in whole or in part with a processor, such as the processor 15. Alternatively, the entire computer readable medium may be present remotely from the processor 15 and coupled to the processor 15 by connection mechanism and/or network cable. In addition to the memory 16, there may be additional memories that may be coupled with the processor 15.

In an embodiment, the processor 15, henceforth referred as the visual search processor 15, may be configured to receive the search query from the network connected device 12. Successively, the visual search processor 15 may process the search query for determining a search result. The search result may be determined based upon matching of information present in the search query with data accessible to the visual search processor 15. In one case, the data may be stored in the memory 16 of the system 13. Thereafter, the visual search processor 15 may forward the search result over the communication network 11 to the network connected device 12. The search result may be displayed on the display screen of the network connected device 12. In one case, the search result may be forwarded to the network connected device 12 as a push notification.

The search result may include purchase opportunity information for products or services identified in the search query. In one case, the search result may further include links directing the user to purchase opportunity resources over the communication network 11. In an embodiment, the visual search processor 15 may provide a link of an e-commerce website for purchasing an article present in the search result, to the user.

FIG. 1B illustrates an exemplary platform architecture 100 for associating the network connected device 12 displayed content, according to an embodiment. The platform architecture 100 may include a monitoring module 110 (i.e., testing/monitoring 110) for tracking a performance. The monitoring module 110 may include uptime module 111, a load testing module 112 (i.e., a load tester 112), and an integration testing functions module 113 (i.e., ci-integration tests 113). The integration testing functions module 113 may connect with a user interface (UI) module 120. The user interface (UI) module 120 may include an analytics visualization module 121 (for example, analytics-Kibana), a merchant interface 122, and a monitoring interface module 123.

Further, the platform architecture 100 may include a service module 130 (e.g., services/APIs 130) having a device-native functionality and interfaces with a lens search 131, an imaging channel 132, e-commerce module 133, authentication 134, analytics 135, backend façade proxy 136, email notifications 137, push notifications 138, and log/journaling services 139 (e.g., logstash 139). The platform architecture 100 may further integrate software-as-a-service (SaaS) 140 providers of content delivery networks 141 (i.e., Cloudinary 141), e-commerce gateway 142 (e.g., Shopify 142), notification services 143 (e.g., AWS SNS 143), back end authentication services 144 (e.g., OAuth.io 144), code (e.g., software update) delivery services 145 (e.g., circle CI 145), and transactional email services 146 (e.g., Mandrill/Mailchimp 146). Further, the platform architecture 100 may include a data module 150 having database 151 (e.g., MongoDB), a storage database 152 (e.g., Storage S3), and visual search indexes 153 (e.g., Elastic Search).

In an embodiment, the user may access the monitoring interface module 123 and the lens search 131 for sending search queries regarding selected and/or isolated images 132 leveraging visual search indexes 152. Further, the user may utilize the e-commerce module 133 and the e-commerce gateway 142 to purchase products and services present and identifies in the search results (i.e., visual search results). It should be noted that such activity may be logged in the log/journaling services 139 that may be analyzed by the user or by third parties.

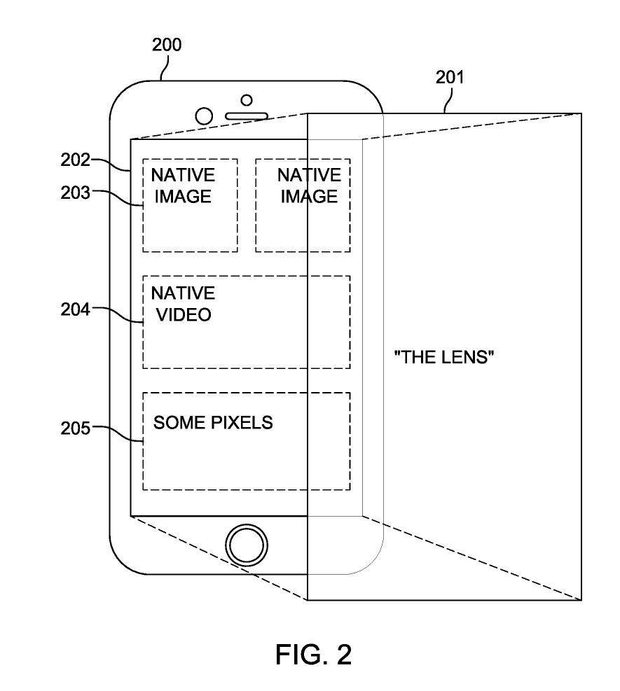

FIG. 2 illustrates an exemplary implementation of the platform architecture 100, according to an embodiment. As shown in FIG. 2, in one case, the network connected device 12 may be a mobile device 200. The mobile device 200 may include a lens-type bounding box 201 of a two-dimensional (x, y) geometry omnipresent on a display screen 202 of the mobile device 200. The lens-type bounding box 201 may be present virtually (i.e., in the background) and invisibly to a user on the mobile device 200. Further, the lens-type bounding box 201 may be referred to as an artificial perimeter present on the display screen 202 of the mobile device 200. It should be noted that the display screen 202 may display native images 203, native video 204, and pixels 205. Further, the lens-type bounding box 201 may exist over and in association with the pixels 205 of the display screen 202.

In one embodiment, the user of the mobile device 200 may actuate the lens-type bounding box 201. Based on such actuation, the lens-type bounding box 201 may entirely or selectively record the underlying pixels 205, the meta-data, and the media components of the content, and thereby forming a search query (i.e., a visual search query). In an example, the media components may correspond to the native images 203 and the native video 204.

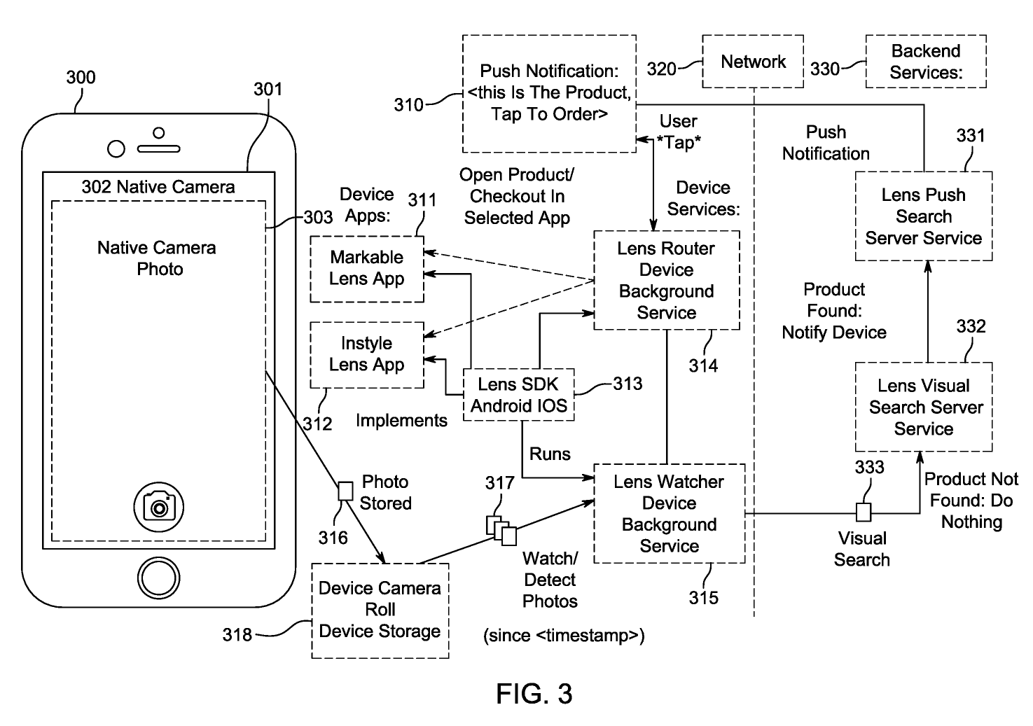

FIG. 3 illustrates an exemplary mobile device 300 receiving a search result via a push notification 310. As shown in FIG. 3, the mobile device 300 may include a display screen 301 over which a lens-type bounding box 302 lays. The display screen 301 may show a photograph 303 captured by a user of the mobile device 300. The photograph 303 may be accessible by the lens-type bounding box 302 and may be searched to identify subjects present in the photograph 303. Based on the identified subjects, a search query may be prepared. In an embodiment, the photograph 303 may be stored in a photo storage module 316 and a lens watcher device background service module 315. Thereafter, the lens watcher device background service module 315 may send the search query over a network 320 to perform a visual search 333 using a lens visual search server service 332.

In an example, the photograph 303 may correspond to a product, then the subject of the photograph may be associated with a reference and “found.” Thereafter, the subject may be notified to the user of the mobile device 300 via the push notification 310 using a lens push search server service 331. In an embodiment, the push notification 310 may be made available to a lens router device background service 314 such that the user may acquire additional information about the subject or make an outright purchase of the search result. It should be noted that interfacing between the lens router device background service 314, the lens watcher device background service 315, and third-party apps e.g., the Markable lens app 311 or an Instyle® lens app 312, may be enabled through a software development kit 313. In one case, the software development kit 313 may be lens SDK adaptable to Android® or iOS® operating systems 313.

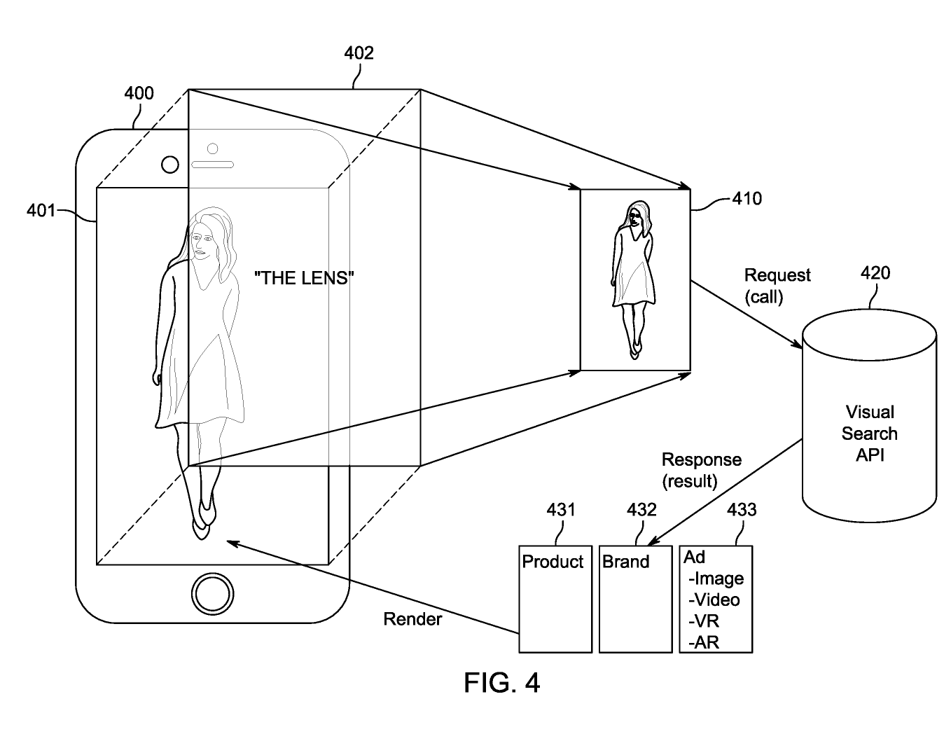

FIG. 4 illustrates an exemplary scenario of a method for performing a visual search of screen content using a mobile device 400, according to an embodiment. As shown in FIG. 4, the mobile device 400 may display a photograph of a woman modeling a dress on a display screen 401. Further, a lens-type bounding box 402 may exist over the display screen 401. In an embodiment, a user may actuate the lens-type bounding box 402 for recording an entire content 410 present on the display screen 401. In an embodiment, the mobile device 400 may compress a size of the content 410 for supporting low-quality network conditions. Successively, the mobile device 400 may forward the content 410 as a search query, to a visual search processor 420 for executing a visual search API. Successively, the visual search processor 420 may process the search query for retrieving one or more search results. In one case, the one or more search results may correspond to product listings 431, brand information 432, and related advertisements 433. Thereafter, the visual search processor 420 may forward the one or more search results to the mobile device 400. The one or more search results may be displayed on the display screen 401 of the mobile device 400. It should be noted that in this embodiment geometry of the lens-type bounding box 402 matches that of the display screen 401 of the mobile device 400. The lens-type bounding box 402 and artificial perimeter it forms may be of any two-dimensional geometry.

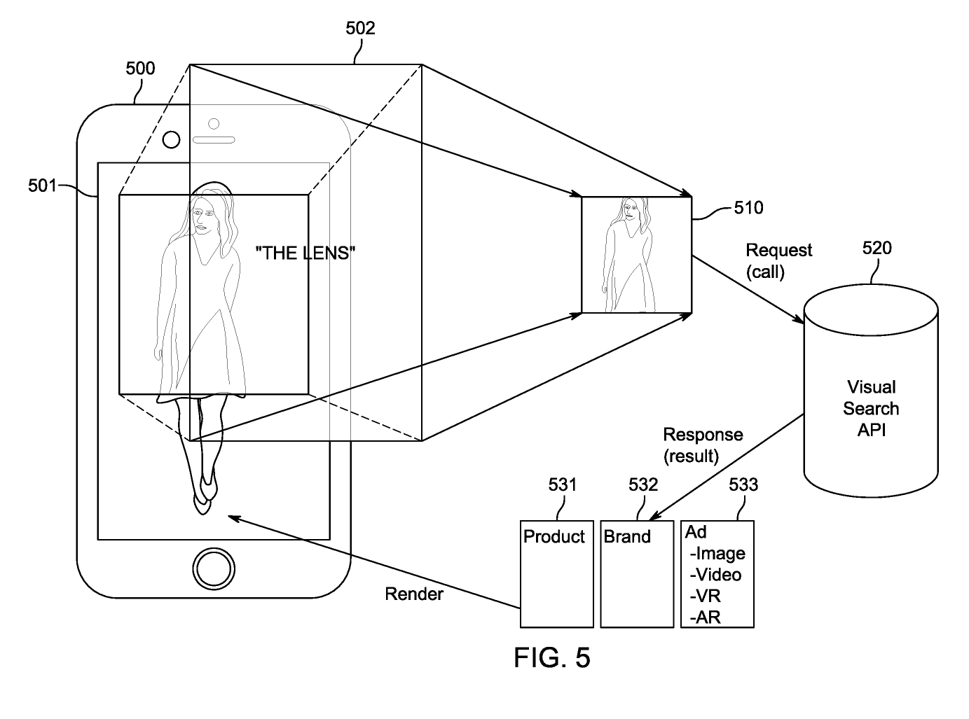

FIG. 5 illustrates another exemplary scenario of a method for performing a visual search of a partial screen content using a mobile device 500, according to an embodiment. As shown in FIG. 5, the mobile device 500 may display a photograph of a woman modeling a dress on a display screen 501. Further, a lens-type bounding box 502 may exist over a portion of the display screen 501. In an embodiment, a user may actuate the lens-type bounding box 502 for recording a portion 510 of content displayed on the display screen 501. In one case, the portion 510 of the content may correspond to a partial screen content. Successively, the mobile device 500 may forward the partial screen content as a search query to a visual search processor 520 (e.g., a visual search API). Successively, the visual search processor 520 may process the search query for retrieving one or more search results. In one case, the one or more search results may correspond to product listings 531, brand information 532, and related advertisements 533. Thereafter, the visual search processor 520 may forward the one or more search results to the mobile device 500. It should be noted that the one or more search results may be displayed on the display screen 501 of the mobile device 500, for providing purchase opportunity information to the user.

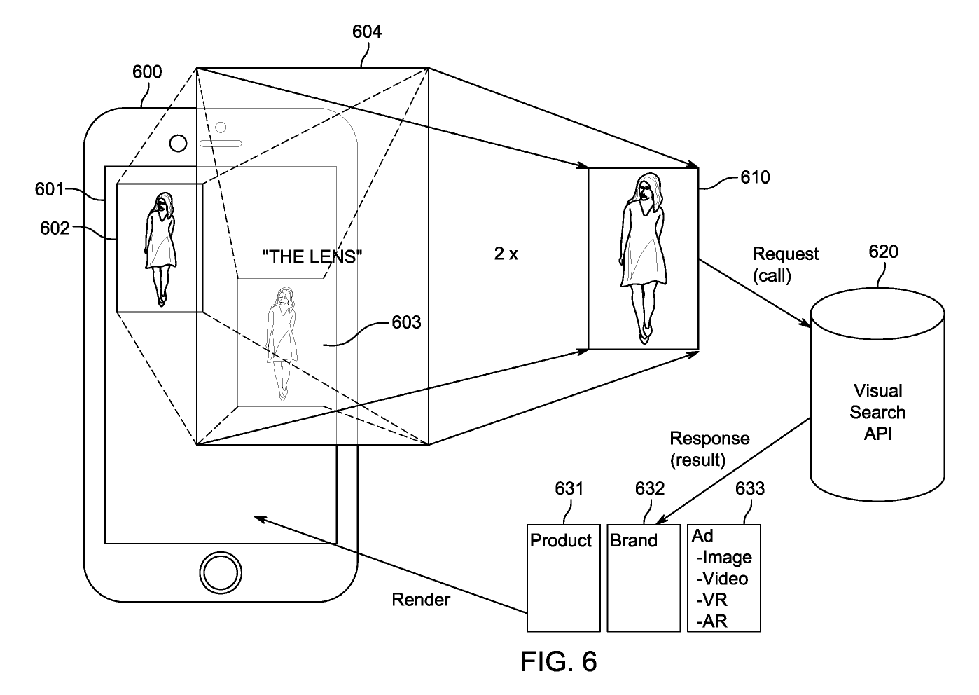

FIG. 6 illustrates another exemplary scenario of a method for performing a visual search of native screen content using a mobile device 600, according to an embodiment. As shown in FIG. 6, the mobile device 600 may display multiple photographs of women modeling a dress on a display screen 601. It should be noted that each photograph 602, 603 may appear natively and independently on the display screen 601. Further, a lens-type bounding box 604 may virtually exist over the display screen 601. In an embodiment, a user may actuate the lens-type bounding box 604 for recording content 610 of the photographs displayed on the display screen 601. Successively, the mobile device 600 may forward the recorded content 610 as a search query to a visual search processor 620 (e.g., a visual search API). Successively, the visual search processor 620 may process the search query for retrieving one or more search results. In one case, the one or more search results may correspond to product information 631, brand information 632, and related advertisements 633. Thereafter, the visual search processor 620 may forward the one or more search results to the mobile device 600. The one or more search results may be displayed on the display screen 601 of the mobile device 600.

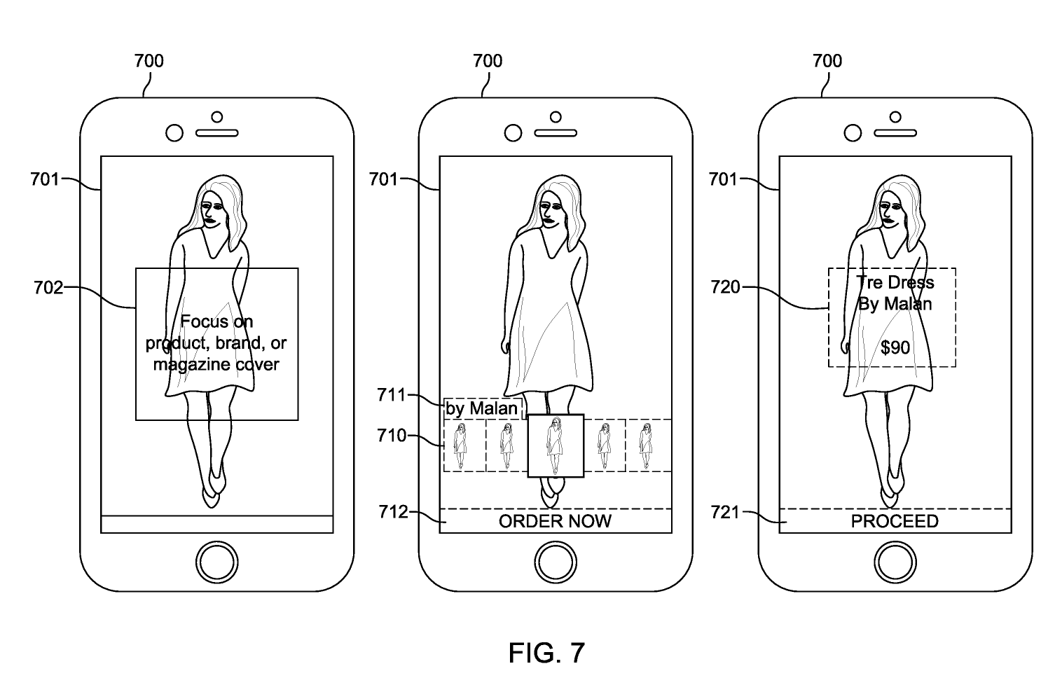

FIG. 7 illustrates an exemplary user interface after a visual search is performed on a mobile device 700, according to an embodiment. FIG. 7 is described in conjunction with the Figures explained above.

As shown in FIG. 7, the mobile device 700 comprises a display screen 701 and a mobile application installed in the mobile device 700. The mobile application may provide a user an ability to manipulate a lens-type bounding box 702 for recording a portion that contains a search subject. In an example, the search subject may correspond to an image. Successively, the image within the lens-type bounding box 702 may be sent to the visual search processor 15. As discussed above, the visual search processor 15 may process the search query for retrieving search results. Successively, the visual search processor 15 may forward the search results to the mobile device 700. Thereafter, the search results may be displayed on the display screen 701 of the mobile device 700.

In one case, the search results may correspond to branding information 711 (for example, Malan), product information 710, and an e-commerce channel 712 (e.g., Order Now option 712). The e-commerce channel 712 may be accessed by the user for purchasing a product. Further, based upon a selection of the product, more product information 720 may be made available on the display screen 701 of the mobile device 700. In an embodiment, the mobile application may provide the user a proceed option 721. The proceed option 721 may correspond to an order confirmation feature.

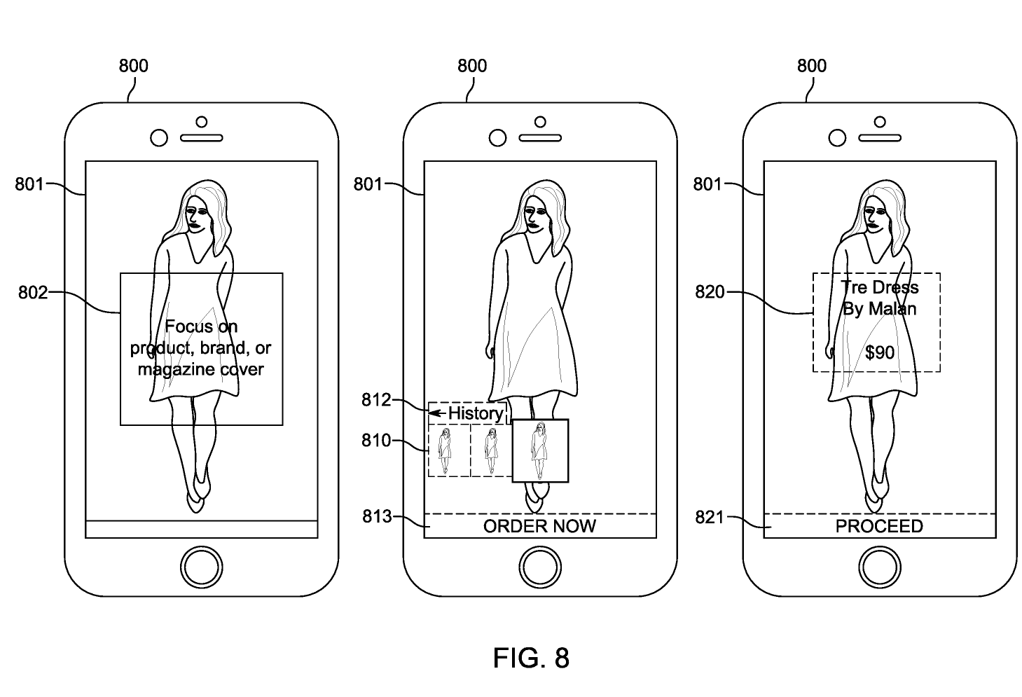

FIG. 8 illustrates another exemplary user interface after a visual search is performed using a mobile device 800, according to an embodiment. FIG. 8 is described in conjunction with the Figures explained above.

As shown in FIG. 8, the mobile device 800 comprises a display screen 801 and a mobile application installed in the mobile device 800. The mobile application may provide a user an ability to manipulate a lens-type bounding box 802 for recording a portion that contains a search subject. In an example, the search subject may correspond to an image. Successively, the image within the lens-type bounding box 802 may be sent to the visual search processor 15. As discussed above, the visual search processor 15 may process the search query for retrieving a plurality of search results 810. Successively, the visual search processor 15 may forward the plurality of search results 810 to the user. The plurality of search results 810 may be displayed on the display screen 801 of the mobile device 800. The plurality of search results 810 may correspond to purchase opportunity information for products or services.

Further, the mobile application may provide a navigation feature 812 to the user. In an example, the navigation feature 812 may allow the user to see the user's history of utilizing the lens-type bounding box 802 and information provided to the user therewith. Further, the search results may include an e-commerce channel 813 (e.g., order now option 813) in a form of an additional layer. The e-commerce channel 813 may be accessed by the user for purchasing a product. Further, based upon a selection of the product, more product information 820 may be made available on the display screen 801 of the mobile device 800. In an embodiment, the mobile application may provide the user a proceed option 821. The proceed option 821 may correspond to an order confirmation feature.

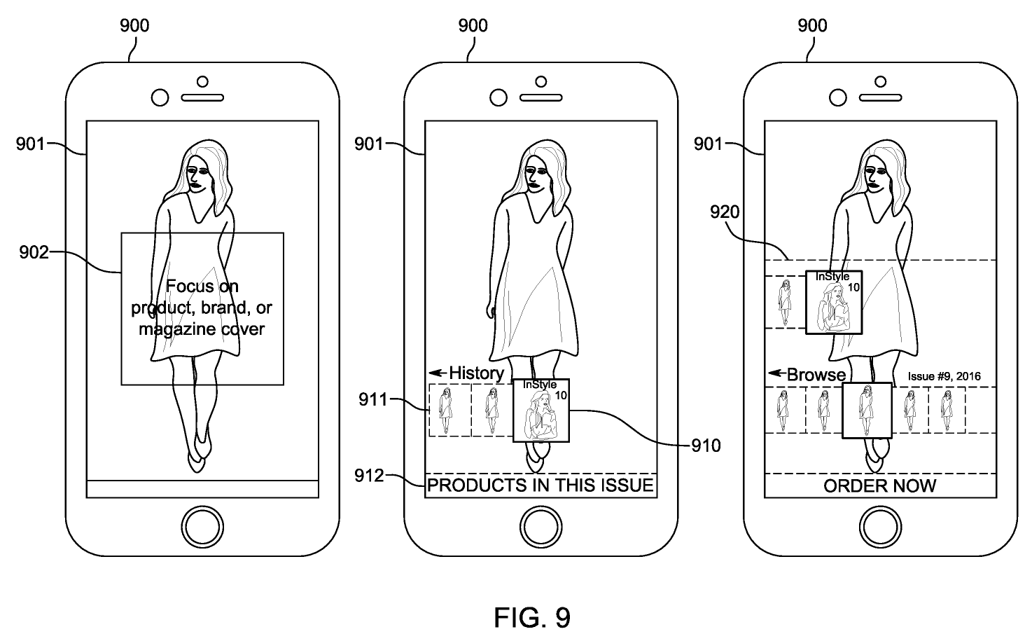

FIG. 9 illustrates another exemplary user interface after a visual search is performed using a mobile device 900, according to an embodiment. FIG. 9 is described in conjunction with the Figures explained above.

As shown in FIG. 9, the mobile device 900 comprises a display screen 901 and a mobile application installed in the mobile device 900. The mobile application may provide a user an ability to manipulate a lens-type bounding box 902 for recording a portion that contains a search subject. In an example, the search subject may correspond to an image. Successively, the image within the lens-type bounding box 902 may be sent to the visual search processor 15. As discussed above, the visual search processor 15 may process the search query for retrieving search results. Successively, the visual search processor 15 may forward the search results to the mobile device 900. Thereafter, the search results may be displayed on the display screen 901 of the mobile device 900.

In one case, the search results may include media references 910 and products information 911. It should be noted that the mobile application may provide products in this issue 912 option for finding more products. Further, based upon the user actuation, the user may be able to access and obtain additional information concerning the media references 910.

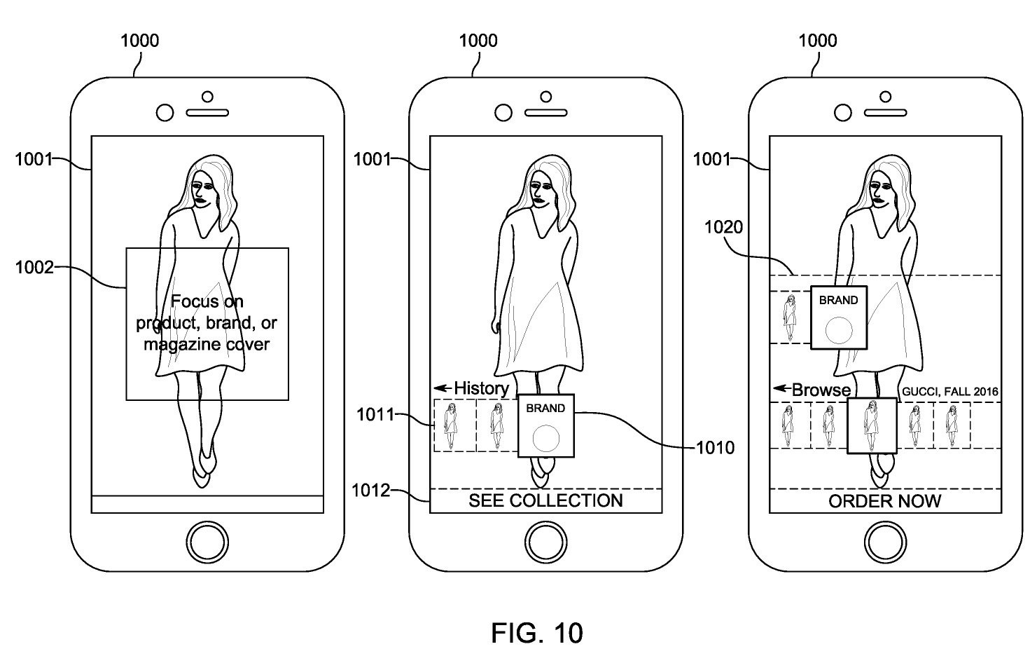

FIG. 10 illustrates another exemplary user interface after a visual search is performed using a mobile device 1000, according to an embodiment. FIG. 10 is described in conjunction with the Figures explained above.

As shown in FIG. 10, the mobile device 1000 comprises a display screen 1001 and a mobile application installed in the mobile device 1000. The mobile application may provide a user an ability to manipulate a lens-type bounding box 1002 for recording a portion that contains a search subject. In an example, the search subject may correspond to an image. Successively, an image within the lens-type bounding box 1002 may be sent to the visual search processor 15. As discussed above, the visual search processor 15 may process the search query for retrieving search results. Successively, the visual search processor 15 may send the search results to the mobile device 1000. Thereafter, the search results may be displayed on the display screen 1001 of the mobile device 1000.

The search results may include branding information 1010 and products information 1011. In an example, the branding information 1010 may be the identity of a particular clothing brand (e.g., Gucci®). It should be noted that the mobile application may provide a “see collection” 1012 option to the user whereby the user may see a catalog of related products. Thereafter, the user may be able to access and obtain more information 1020 related to the brand.

It will be apparent to one skilled in the art that the mobile devices 200, 300, 400, 500, 600, 700, 800, 900, and 1000 mentioned above have been provided only for illustration purposes. In an embodiment, tablet devices, desktop computers, and virtually any network-connected computing devices may be used as well, without departing from the scope of the disclosure.

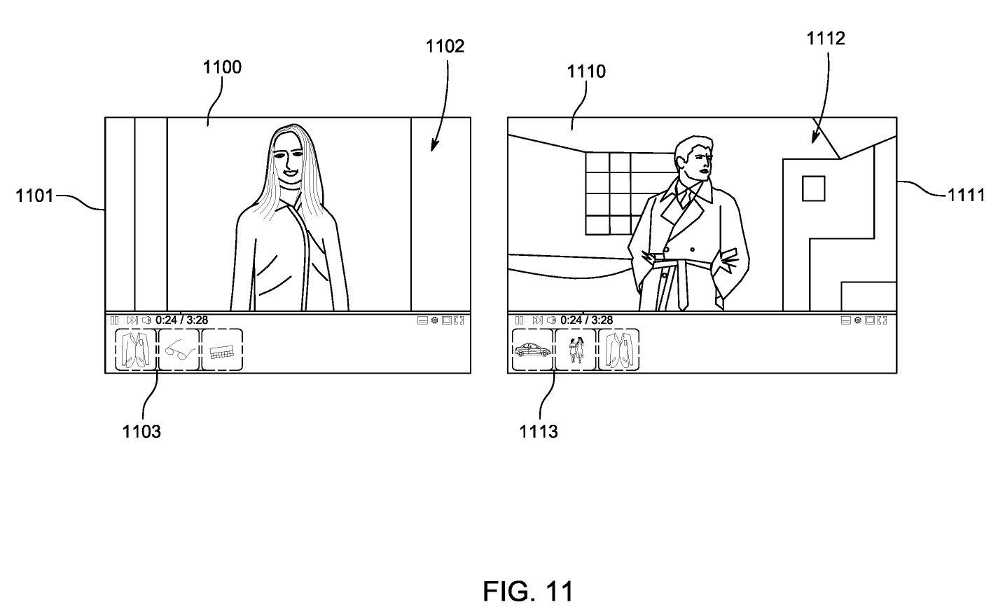

FIG. 11 illustrates an alternate embodiment of the system 13 for associating the network connected device 12 displayed video content, according to an embodiment. FIG. 11 is described in conjunction with the Figures explained above.

As shown in FIG. 11, a video content 1100 may be played within a video player 1101 occupying a portion of a display screen 1102 of the network connected device 12. Successively, based upon the user actuation or triggering of an event, the video content 1100 may be recorded and sent to the visual search processor 15. As discussed above, the visual search processor 15 may process the search query for retrieving the search results. Successively, the visual search processor 15 may send the search results to the network connected device 12. Thereafter, the search results may be displayed on the display screen 1102. In one case, the search results may correspond to products 1103 identified within the search subject video. In an embodiment, a region of the display screen 1102 may be actuated by the user to retrieve additional product information and purchase opportunities.

Similarly, video content 1110 may be played within a video player 1111 occupying a portion of a display screen 1112 of the network connected device 12. Successively, based upon the user actuation or triggering of the event, the video content 1110 may be recorded and sent to the visual search processor 15. As discussed above, the visual search processor 15 may process the search query for retrieving the search results. Successively, the visual search processor 15 may send the search results to the user. Thereafter, the search results may be displayed on the display screen 1112. In one case, the search results may correspond to products 1113 identified within the search subject video. In an embodiment, a region of the display screen 1112 may be actuated by the user to retrieve additional product information and opportunities.

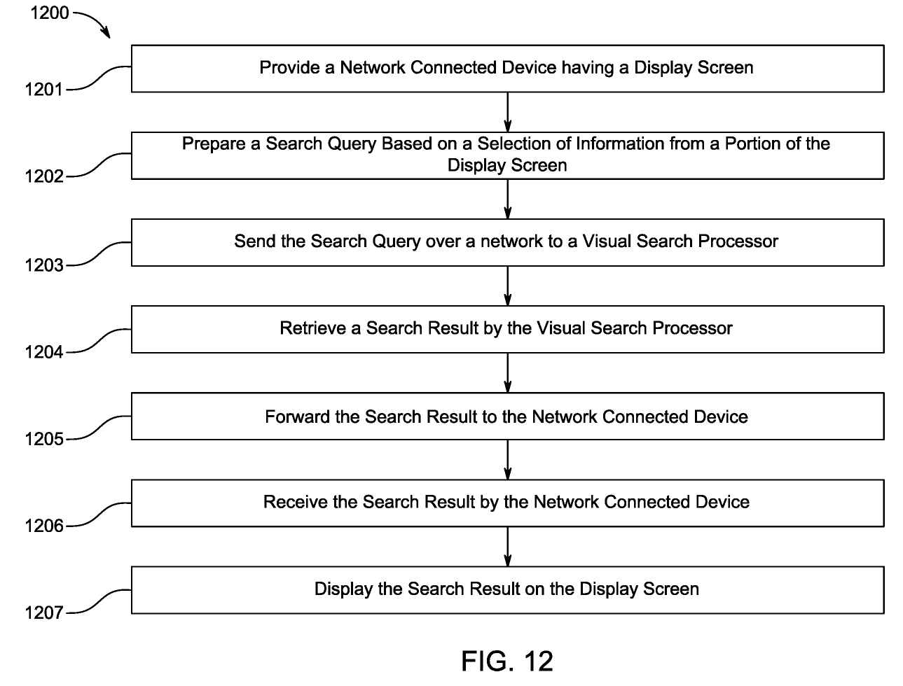

FIG. 12 illustrates a flowchart 1200 showing a method for associating the network computed device 12 displayed content. FIG. 12 comprises a flowchart 1200 that is explained in conjunction with the elements disclosed in Figures explained above.

The flowchart 1200 of FIG. 12 shows the architecture, functionality, and operation for associating the network computed device 12 displayed content. In this regard, each block may represent a module, segment, or portion of code, which comprises one or more executable instructions for implementing the specified logical function(s). It should also be noted that in some alternative implementations, the functions noted in the blocks may occur out of the order noted in the drawings. For example, two blocks shown in succession in FIG. 12 may in fact be executed substantially concurrently or the blocks may sometimes be executed in the reverse order, depending upon the functionality involved. Any process descriptions or blocks in flowcharts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine. The flowchart 1200 starts at the step 1201 and proceeds to step 1207.

At step 1201, a network connected device 12 may be provided. The network connected device 12 may comprise a display screen.

At step 1202, a search query may be prepared based on a selection of information from at least one portion of the display screen of the network connected device 12. The selection of information may be done manually by the user or using a programmed script. The selection of information may be made using an artificial perimeter present on the display screen of the network connected device 12. In an example, the artificial perimeter may be a lens-type bounding box. In one case, the selection of information may correspond to at least one of the underlying pixels, meta-data, and media components of the content within the artificial perimeter.

At step 1203, the search query may be sent to the visual search processor 15 over the communication network 11.

At step 1204, a search result may be retrieved by the visual search processor 15. The search result may be retrieved upon matching of the information present in the search query with data accessible to the visual search processor 15.

At step 1205, the search result may be forwarded to the network connected device 12 over the communication network 11. It should be noted that the search result may be forwarded by the visual search processor 15.

At step 1206, the search result may be received by the network connected device 12. At step 1207, the search result may be displayed on the display screen of the network connected device 12.

Although the above detailed descriptions relate to specific preferred embodiments as the inventor presently contemplates, it will be understood that the invention in its broad aspects includes mechanical, chemical, and functional equivalents of the elements described herein. Various details of design and construction may be modified without departing from the true spirit and scope of the invention which is set forth in the following claims. Other embodiments, which will be apparent to those skilled in the art and which practice the teachings herein set forth, are intended to be within the scope and spirit of the invention.

1. A method for associating network connected device displayed content, the method comprising:
providing the network connected device, the network connected device having a display screen;
preparing a search query based on a selection of information from at least a portion of the display screen of the network connected device, wherein the selection is made using an artificial perimeter present on the display screen of the network connected device, and wherein the selection of information corresponds to at least one of underlying pixels, meta-data, and media components of the content within the artificial perimeter;
sending the search query over a network to a visual search processor for retrieving a search result, wherein the search result is retrieved upon matching of the information present in the search query with data accessible to the visual search processor;
forwarding, by the visual search processor, the search result over the network to the network connected device;
receiving the search result by the network connected device; and
displaying the search result on the display screen.

2. The method of claim 1, wherein the search result is received by the network connected device as a push notification.

3. The method of claim 1, wherein the search result comprises purchase opportunity information for products or services identified in the search query.

4. The method of claim 3, wherein the search result further comprises links directing a user to purchase opportunity resources over the network.

5. The method of claim 1, further comprising compressing a size of the information within the search query for supporting low-quality network conditions.

6. The method of claim 1, further comprising providing a link of an e-commerce website for purchasing an article present in the search result.

7. The method of claim 1, wherein the selection of information is done manually by the user or using a programmed script.

8. A method for associating network connected device displayed content, the method comprising:
receiving, by a visual search processor, a search query over a network, for retrieving a search result derived from matching of information present in the search query with data accessible to the visual search processor, wherein the search query is prepared, using an artificial perimeter present on a display screen of the network connected device, using information related to at least one of underlying pixels, meta-data, and media components of the content within the artificial perimeter; and
forwarding, by the visual search processor, the search result over the network to be displayed on the display screen of the network connected device.

9. The method of claim 8, wherein the search result is forwarded to the network connected device as a push notification.

10. The method of claim 8, wherein the search result comprises purchase opportunity information for products or services identified in the search query.

11. The method of claim 10, wherein the search result further comprises links directing a user to purchase opportunity resources over the network.

12. The method of claim 8, further comprising providing a link of an e-commerce website for purchasing an article present in the search result.

13. A system for associating network connected device displayed content, the system comprising:
a network connected device comprising a display screen, wherein the network connected device is configured to:
prepare a search query based on a selection of information from at least a portion of the display screen of the network connected device, wherein the selection is made using an artificial perimeter present on the display screen of the network connected device, and wherein the selection of information corresponds to at least one of underlying pixels, meta-data, and media components of the content within the artificial perimeter; and
send the search query over a network to a visual search server;
wherein the visual search server is connected to the network connected device through the network, wherein the visual search server is configured to:
retrieve a search result based on the search query, wherein the search result is retrieved upon matching of the information present in the search query with data accessible to the visual search server; and
forward the search result, over the network, to the network connected device, wherein the network connected device receives the search result and displays the search result on the display screen.

14. The system of claim 13, wherein the search result is received by the network connected device as a push notification.

15. The system of claim 13, wherein the search result comprises purchase opportunity information for products or services identified in the search query.

16. The system of claim 15, wherein the search result further comprises links directing a user to purchase opportunity resources over the network.

17. The system of claim 13, further comprising compressing a size of the information within the search query for supporting low-quality network conditions.

18. The system of claim 13, further comprising providing a link of an e-commerce website for purchasing an article present in the search result.

19. The system of claim 13, wherein the selection of information is done manually by the user or using a programmed script.

20. A system for associating network connected device displayed content, the system comprising:
a visual search processor; and
a memory connected to the visual search processor, wherein the memory comprises programmed instructions executed by the visual search processor to:
receive a search query over a network, for retrieving a search result derived from matching of information present in the search query with data accessible to the visual search processor, wherein the search query is prepared, using an artificial perimeter present on a display screen of a network connected device, using information related to at least one of underlying pixels, meta-data, and media components of the content within the artificial perimeter; and
forward the search result over the network for displaying on the display screen of the network connected device.

21. The system of claim 20, wherein the search result is forwarded to the network connected device as a push notification.

22. The system of claim 20, wherein the search result comprises purchase opportunity information for products or services identified in the search query.

23. The system of claim 22, wherein the search result further comprises links directing a user to purchase opportunity resources over the network.

24. The system of claim 20, further comprising providing a link of an e-commerce website for purchasing an article present in the search result.

25. A non-transient computer-readable medium comprising instructions for causing a programmable processor to:
prepare a search query based on a selection of information from at least a portion of a display screen of a network connected device, wherein the selection is made using an artificial perimeter present on the display screen of the network connected device, and wherein the selection of information corresponds to at least one of underlying pixels, meta-data, and media components of the content within the artificial perimeter;
send the search query over a network to a visual search processor for retrieving a search result, wherein the search result is retrieved upon matching of the information present in the search query with data accessible to the visual search processor;
forward the search result over the network to the network connected device;
receive the search result by the network connected device; and
display the search result on the display screen.
